(19) United States
(12) Patent Application Publication
(10) Pub. No.: US 2018/0308039 A1
(43) Pub. Date: Oct. 25, 2018

(54) System and Method for Dynamically Establishing A Regional Distribution Center Truck Flow Graph to Distribute Merchandise

(71) Applicant: Walmart Apollo, LLC, Bentonville, AR (US)

(72) Inventors: Behzad Nemati, Springdale, AR (US); Ehsan Nazarian, Rogers, AR (US)

(73) Assignee: Walmart Apollo, LLC, Bentonville, AR (US)

(21) Appl. No.: 15/960,687

(22) Filed: Apr. 24, 2018

Related U.S. Application Data
(60) Provisional application No. 62/489,114, filed on Apr. 24, 2017.

(51) Int. Cl. G06Q 10/08; G06N 99/00; G06Q 30/02

(52) U.S. Cl. CPC G06Q 10/083; G06Q 10/087; G06Q 30/0202; G06N 99/005

(57) ABSTRACT

Systems, methods, and computer-readable storage media for establishing an inter-distribution truck flow to distribute merchandise. Using machine learning, a forecast for retail demand of a product is made. Real-time updates of the product inventory at both retail locations and distributions are received, and a graph identifying preferred routes between distribution centers is used, to arrange a shipment to move a needed amount of the product between distribution centers. Based on that shipment, the machine learning algorithm and the graph are updated, such that subsequent shipping occurs more efficiently.

### BACKGROUND

### 1. Technical Field

The present disclosure relates to dynamically establishing transport flow between regional distribution centers, and more specifically to using real-time data to generate a dynamic transport flow graph, then make shipping assignments based on the current transport flow graph.

### 2. Introduction

Product distribution systems often follow a model where the manufacturer of a product delivers a finished product to a distribution center for a retailer, then the retailer transports the product from the distribution center to nearby retail locations. For example, a manufacturer of toothpaste who has contracted with a retailer to sell the toothpaste in retail stores will deliver a truckload of toothpaste product to a distribution center associated with the retailer. The retailer will then send trucks from the distribution center to retail locations for sale to customers, each truck having some toothpaste as well as other products. In some instances, it can be necessary or desirable to shift merchandise between distribution centers, however many retailers do not have mechanisms in place for moving merchandise between distribution centers.

### SUMMARY

A method which practices the concepts disclosed herein may include: forecasting, via a processor implementing a machine learning retail demand algorithm, a predicted demand for a product in a retail store, wherein the machine learning retail demand algorithm uses a real-time inventory level of the product in the store with historical sales data to identify the predicted demand; based on the predicted demand and by accessing, in real-time, a distribution center inventory system, identifying the product as stored at a first distribution center and needing to be delivered to a second distribution center before being redistributed to the retail store; retrieving, from a database, an inter-distribution center graph which provides current truck routes between a plurality of distribution centers, the plurality of distribution centers comprising the first distribution center and the second distribution center; identifying, via the processor and based on the inter-distribution center graph, a previously authorized route for distributing merchandise between the first distribution center and the second distribution center; initiating, via the processor, instructions for a truck to deliver the product from the first distribution center to the second distribution center, to yield a delivery; based on time required for the delivery and costs associated with the delivery, updating, via the processor, the inter-distribution center graph, to yield an updated inter-distribution center graph, wherein the updated inter-distribution center graph has at least one inter-distribution center route with a lower cost for moving goods from a first distribution center to a second distribution center than a cost for moving the goods from the first distribution center to the second distribution center using routes provided by the inter-distribution center graph; based on inventory levels and sales of the product at the retail store, updating, via the processor, the machine learning retail demand algorithm, to yield an updated machine learning retail demand algorithm; and implementing the updated inter-distribution center graph and the updated machine learning retail demand algorithm in forecasting demand and distribution in a subsequent iteration.

A system configured to practice concepts as disclosed herein may include: a processor; and a computer-readable storage medium having instructions stored which, when executed by the processor, cause the processor to perform operations comprising: forecasting, via a machine learning retail demand algorithm, a predicted demand for a product in a retail store, wherein the machine learning retail demand algorithm uses a real-time inventory level of the product in the retail store with historical sales data to identify the predicted demand; based on the predicted demand and by accessing, in real-time, a distribution center inventory system, identifying the product as stored at a first distribution center and needing to be delivered to a second distribution center before being redistributed to the retail store; retrieving, from a database, an inter-distribution center graph which provides current truck routes between a plurality of distribution centers, the plurality of distribution centers comprising the first distribution center and the second distribution center; identifying, based on the inter-distribution center graph, a previously authorized route for distributing merchandise between the first distribution center and the second distribution center; initiating instructions for a truck to deliver the product from the first distribution center to the second distribution center, to yield a delivery; based on time required for the delivery and costs associated with the delivery, updating the inter-distribution center graph, to yield an updated inter-distribution center graph, wherein the updated inter-distribution center graph has at least one inter-distribution center route with a lower cost for moving goods from a first distribution center to a second distribution center than a cost for moving the goods from the first distribution center to the second distribution center using routes provided by the inter-distribution center graph; based on inventory levels and sales of the product at the retail store, updating the machine learning retail demand algorithm, to yield an updated machine learning retail demand algorithm; and implementing the updated inter-distribution center graph and the updated machine learning retail demand algorithm in forecasting demand and distribution in a subsequent iteration.

A non-transitory computer-readable storage medium configured according to the concepts the concepts disclosed herein may cause a computing device to perform operations including: forecasting, via a machine learning retail demand algorithm, a predicted demand for a product in a retail store; based on the predicted demand, identifying the product as stored at a first distribution center and needing to be delivered to a second distribution center before being redistributed to the retail store; retrieving, from a database, an inter-distribution center graph which provides current truck routes between a plurality of distribution centers, the plurality of distribution centers comprising the first distribution center and the second distribution center; identifying, based on the inter-distribution center graph, a previously authorized route for distributing merchandise between the first distribution center and the second distribution center; initiating instructions for a truck to deliver the product from the first distribution center to the second distribution center, to yield a delivery; based on time required for the delivery and costs associated with the delivery, updating the inter-distribution center graph, to yield an updated inter-distribution center graph; based on inventory levels and sales of the product at the retail store, updating the machine learning retail demand algorithm, to yield an updated machine learning retail demand algorithm; and implementing the updated inter-distribution center graph and the updated machine learning retail demand algorithm in forecasting demand and distribution in a subsequent iteration.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

FIG. 1 illustrates a first exemplary distribution system;

FIG. 2 illustrates a second exemplary distribution system;

FIG. 3 illustrates an exemplary flowchart for predicting inventory levels using machine learning;

FIG. 4 illustrates an exemplary method embodiment; and

FIG. 5 illustrates an exemplary computer system which can be used to practice the concepts disclosed herein.

### DETAILED DESCRIPTION

Retailer's often use distribution systems where the products are delivered to distribution centers by third party suppliers, then moved to individual retail stores based on the retailer's estimated demands for the product. Because of this distribution system, transporting goods between individual distribution centers seldom occurs. However, when supplies do need to be moved between distribution centers, the process and routes used to move the goods between distribution centers can be inefficient. For example, the cost to move the goods from one distribution center to another may outweigh the potential profits of the product, and therefore not be an efficient use of resources. Likewise, moving the goods directly from distribution center A to distribution center B may be more expensive than moving goods from distribution center A to distribution center C, then to distribution center B.

To correct for these inefficiencies, systems configured according to the principles disclosed herein can dynamically establish a regional distribution center truck flow graph to distribute merchandise. The dynamic graph, and making subsequent shipping assignments based on a current version of the dynamic graph, can dynamically shift based on real-time conditions to provide increased efficiency in (1) the cost of transporting goods, (2) the time to transport goods, (3) the use of shipping capacity in transporting goods, and/or (4) inventory storage at the distribution centers.

As an example, the system can have a graph identifying specific roads and routes which trucks should use to move goods for a retailer between two distribution centers. The system uses the graph to make shipping assignments between the distribution centers, seeking to minimize the costs of shipping goods between the distribution centers. However, the graph is not permanent. To make changes to the graph, the system can receive real-time route data regarding roads and routes, such as data regarding route conditions, the cost of fuel on the route, time required to deliver goods on the route, etc. This data can be received using group-aggregation software from other drivers (such as WAZE©), can be based on reports from government sources (i.e., state highway patrol reports, local police reports) regarding the road conditions, or can be based on can be based on feedback from trucks driving the routes. The system can also receive real-time updates regarding fuel pricing, where every time a change to a gas price occurs, the system receives an electronic notification of the change.

As the system is receiving these real-time and/or periodic updates to the graph data, the system is simultaneously testing alternative graphs to determine if routes contained within an alternative graph can result in cost savings to the retailer. When the system identifies an improvement can be made, the previous graph is replaced by an updated graph, which is then used in making assignments to trucks and other transport vehicles.

In some circumstances, changing the graph immediately upon real-time data being received and processed can be less than ideal. In such instances, the system can update the graph periodically (i.e., once a month, or once a quarter). Because the updates will not be happening immediately based on real-time data, data in such configurations can be received or updated based on how often the graph is updated. That is, if the route graph will be updated monthly, the system can request and/or receive information regarding road conditions, traffic, fuel prices, etc., on a monthly basis. Alternatively, the system can continue receiving the data in real-time, record the data in a historical database, and make routing decisions for the graph based on the historical data. In this manner, the system can use historical averages, trends, peak traffic times, etc., in establishing the graph and in updating the graph in subsequent iterations.

Graphs, as used herein, are models with nodes and edges. The edges as used herein can be undirected or directed, with preference for directed edges. Within graphs using directed edges there can be two edges between a pair of nodes, indicating bi-directional flow between the nodes. The nodes and/or edges can be weighted based on data received, with the weights reflecting demand, costs, transit time, and/or other factors. In addition, the graph can be multi-layered to account for specific factors. For example, the graphs described herein are concerned with shipping routes (edges) between distribution centers (nodes). However, within a current graph, there can be layers based on specific times of day, such that the preferred routes for moving merchandise in the morning may not match the preferred routes in the evening. Likewise, the graph may have layers dedicated to specific goods (i.e., a route for hazardous material and a distinct route for waste material; perishable goods versus non-perishable), transportation type (i.e., truck, train, or ship), and/or driver (i.e., some drivers may excel at distinct routes).

The graph can be based on a machine learning algorithm to predict retail demand for retail stores serviced by the individual distribution centers. The machine learning algorithm iteratively improves predictions of the demand at the retail locations by receiving new data regarding actual sales of products, then updating the parameters of the machine learning algorithm. Using the demand predictions and the current inventory levels at the retail locations and/or the distribution centers, the system can determine how much merchandise needs to be delivered to particular distribution centers, as well as the surplus amounts of inventory at other locations. The system then creates the graph to identify how to move the surplus inventory from the distribution centers having surplus goods to those distribution centers which need the merchandise.

In some configurations, the iterative updates to the machine learning algorithm are tailored based on distinct aspects of the data being received. For example, in some configurations, the timeframe for which data is available, as well as the seasonality of the data (i.e., how often certain patterns appear in the data, such as weekly, monthly, quarterly, annually), are used to define sets of data and train the machine learning algorithm. In a preferred configuration, the sets used to train the algorithm represent both a good portion of the overall data as well as the seasonality of the data. For example, if the system has three years of data with an annual seasonality/pattern, the system can use two years as a training set and one year as a testing set, whereas if the three years of data had a monthly seasonality/pattern, the system could use 32 months as training data and four months as a testing set. The seasonality in the data can also contribute to the frequency of the iterative updates. Fast changing items and categories would require more frequent updates compared to more stable items and categories. Each iteration would bring in, for example, newly added historical data, and from that newly added historical data, the machine learning algorithm can provide updated forecasts of demand.

By using this iterative machine learning, the supply chain can become more efficient and robust, and the supply chain can adapt to changing demands, supply, etc. Predicting the demand for products can be based on historical sales information stored within a database, as well as the historical sales information for products similar to a particular product. Determining the similarity can be done using a similarity index, where attributes of products are stored and compared against one another. In one configuration, the similarity index can take the form of a table, where attributes of each and every product sold by the retailer are recorded. The attributes of the new product may be associated with the attributes in the table. Exemplary attributes of a product can include the weight, volume, material, color, brand, product category, number of non-retail units contained within the product, calorie count, etc. For any particular product, the attributes of the product are static, as compared to other data (sales data, marketing data, location within a store, etc.) which may vary over time. When new versions of the product (i.e., new label, new configuration, new quantity, etc.) are released, the retailer can either revise the information associated with the product or, preferably, augment the similarity index with new or updated information.

Attributes for an item can be entered into the system via manual entry. For example, a human operator can manually type or otherwise enter the attributes into a computer-based storage system containing the similarity index. Alternatively, a three-dimensional scanner can be used to record scan the item, then send the item attributes to a server or database storing the similarity index. The three-dimensional scanner can, for example, record information about the shape, color, weight, etc., of the item.

The system then uses the similarity index to compare one item to other items, and can develop a similarity prediction based on how the item in question relates to those other items. In some configurations, this similarity prediction is the result of a weighted equation. For example, comparing a wooden chair to a candy bar using the similarity index could result in a similarity score which is computed: similarity score=0.2*color difference+0.2*brand difference+0.2*size difference+0.4*product type difference. Because a chair and a candy bar are likely to have large distinctions in brand, size, and product types, the similarity score in this example will be quite large (indicating that the products are not similar). By contrast, a similar comparison of two types of candy bars is likely to result in smaller distinctions, and therefore a smaller similarity score will result (indicating that the products are more similar) should the same weighted equation (or a similar equation) be used to determine similarity of a product to other products. Alternatively, the similarity score can be a weighted equation, where data (such as historical sales data) from similar products can be input into the equation based on the similarity.

Using the similarity score and/or the similarity index, the historical performance/demand of other products can be used to predict what the future demand for the particular item will be. For example, based on a similarity score the system retrieves the historical sales data for the top two products which are most similar to the product in question. The system can then use the historical sales data of those two similar products in forming a prediction of the demand for the item. In other configurations, the system can use the similarity score to obtain distinct amounts of data. For example, in some configurations, the system can select only the historical data associated with the most-similar product previously sold in making the demand prediction. In other configurations, the system can collect the historical data associated with any products above a threshold similarity (i.e., if the system computes that two products are 75% similar, it will use the historical sales data of the other product as part of the demand prediction, along with other products also above the 75% similarity threshold). In yet other configurations, the system can weight historical sales data based on the level of similarity.

The predicted demand can also be based on customer orders (for online sales) and in-store purchases of related products, as determined by the similarity index. To support this, systems configured according to this disclosure can receive real-time notifications of sales or orders of the related products. Likewise, the predicted demand can be based on the amount of inventory of products which will compete with, or replace, the product (i.e., replacement products). For example, the system can receive a real-time inventory amount in the form of an electronic signal sent from a store-specific server, the electronic signal conveying (1) the product identification for the product sold, and (2) the store's current inventory of the product sold. In some configurations, the current inventory can be further analyzed in view of the percentage of current inventory available

Other factors which can be used to predict the demand of a product at a retail location can be calendar events (weekdays versus weekends, holidays, etc.), marketing/advertising, response times to new products for customers in a particular region, national/regional distribution (if, for example, the product has already been introduced in major markets, there may be increased demand for it in a rural location when it is introduced), online reviews, newspaper reviews, magazine reviews, and the distribution of samples to key individuals in a community.

The system then employs modeling to predict the amount of the product which is needed at each location within the retailer network. In some cases, this prediction can be made using time series and regression modeling based on the historical data of other products based on the similarity value. In other configurations, the prediction can be made using a machine learning algorithm. After each prediction is made via the machine learning algorithm, the algorithm can be updated based on actual sales of the product. The upgraded/improved machine learning algorithm can then be used to make the subsequent demand prediction. In yet other configurations, time series and regression modeling using the historical data of products can be performed in parallel with machine learning. The results of this parallel processing can then be either the model which has the best record of accurate predictions, or can be a combination of the machine learning prediction and the time series and regression modeling prediction. Making predictions in this manner can help reduce the noise and uncertainty inherent in predicting demand for a new product.

With the graph constructed using predicted demand, real-time inventory levels, costs of shipping, time to ship, and the other factors described above, the system can make assignments to transports to transfer goods between distribution centers using the graph. For example, if the system determines that four hundred boxes of cereal should be transferred from one distribution center to another, the system can (1) identify what transportation options are available to perform the transfer (based on real-time status updates obtained from the transports themselves, or from a server configured to maintain transport status) and (2) based on the graph, assign transports (previously identified in the transportation options) to transfer the goods from one distribution center to another using routes as established by the graph. The assigned transport then moves the goods between the distribution centers.

During, or after, the shipment, shipment information associated with the shipment can be sent to a database. For example, as a truck moves merchandise between distribution centers, information related to the traffic conditions, open/closed roads, average transport times, and/or average transport speeds, etc., can be electronically transmitted to a server which can record the data in a historical database. This data can then be used to update the graph which defines routes between distribution centers (an “inter-distribution center graph”). In other configurations, the data can be uploaded to the server after the delivery of the goods to the distribution center, and the system can, upon receiving the data for that trip, cause an updating of the inter-distribution center graph.

The concepts disclosed herein can also be used to improve the computing systems which are performing, or enabling the performance, of the disclosed concepts. For example, information associated with routes, deliveries, truck cargo, distribution center inventory or requirements, retail location inventory or requirements, etc., can be generated by local computing devices. In a standard computing system, the information will then be forwarded to a central computing system from the local computing devices. However, systems configured according to this disclosure can improve upon this “centralized” approach.

One way in which systems configured as disclosed herein can improve upon the centralized approach is combining the data from the respective local computing devices prior to communicating the information from the local computing devices to the central computing system. For example, a truck traveling from a distribution center to a retail location may be required to generate information about (1) the route being travelled, (2) space available in the truck for additional goods, (3) conditions within the truck, etc. Rather than transmitting each individual piece of data each time new data is generated, the truck processor can cache the generated data for a period of time and combine the generated data with any additional data which is generated within the period of time. This withholding and combining of data can conserve bandwidth due to the reduced number of transmissions, can save power due to the reduced number of transmissions, and can increase accuracy due to holding/verifying the data for a period of time prior to transmission.

Another way in which systems configured as disclosed herein can improve upon the centralized approach is adapting a decentralized approach, where data is shared among all the individual nodes/computing devices of the network, and the individual computing devices perform calculations and determinations as required. In such a configuration, the same truck described above can be in communication with the retail location and the distribution center, and can make changes to the route, destination, pickups/deliveries, etc., based on data received and processed while enroute between locations. Such a configuration may be more power and/or bandwidth intensive than a centralized approach, but can result in a more dynamic system because of the ability to modify assignments and requirements immediately upon making that determination. In addition, such a system can be more secure, because there are multiple points of failure (rather than a single point of failure in a centralized system).

It is worth noting that a “hybrid” system might be more suitable for some specific configurations. In this approach, a part of the network/system would be using the centralized approach (which can take advantage of the bandwidth savings described above), while the rest of the system is utilizing a de-centralized approach (which can take advantage of the flexibility/increased security described above). For instance, the trucks could be connected to a central server at the distribution center, while that server is connected to a decentralized network of store computers.

Having provided a broad description of the concepts of this invention, the disclosure now provides description of the specific embodiments shown in the illustrations. While specific implementations are described, it should be understood that this is done for illustration purposes only. Other components and configurations may be used without parting from the spirit and scope of the disclosure.

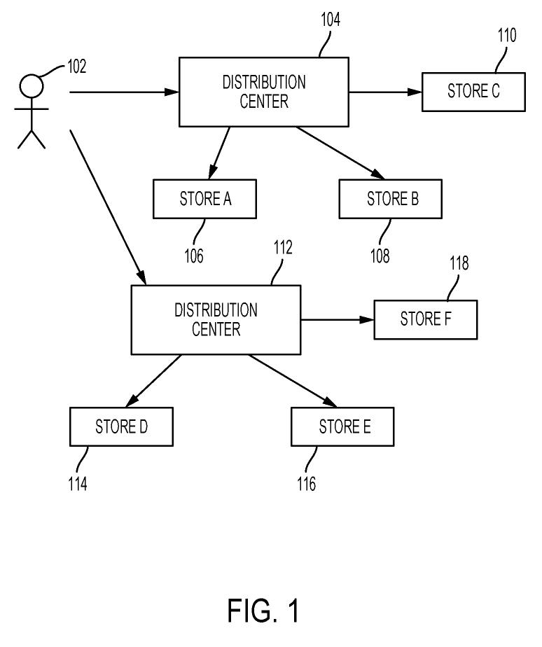

FIG. 1 illustrates an exemplary distribution system. In this example, a product supplier 102 delivers merchandise to distribution centers 104, 112, which in turn distribute the merchandise as required to retails stores 106-110, 114-118. Assignment of the retail stores 106-110, 114-118 to a particular distribution center 104, 112 can, for example be based on geographic location/region. While the retailer using such a distribution system can perform analyses resulting in projected demand at the retail stores 106-110, 114-118, and can use those projections to determine how much of a given product to store at the respective distribution centers 104, 112, the illustrated distribution system does not present any route for transferring goods between the distribution centers 104, 112.

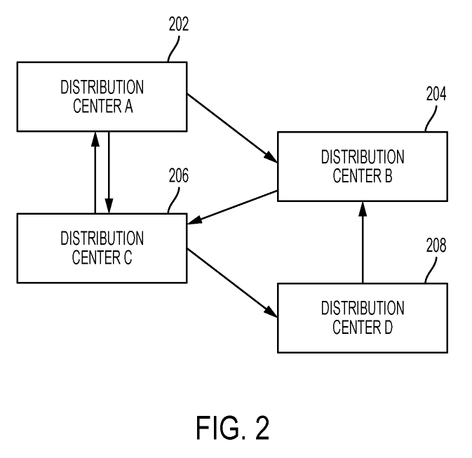

FIG. 2 illustrates a graph containing nodes of distribution centers 202-208, with directional edges between the nodes 202-208 indicating how goods are moved between the distribution centers 202-208. In this example, each distribution center 202-208 has at least one edge indicating where goods from that distribution center are to be delivered, and at least one edge indicating from where goods are to be received. In addition, between distribution center A 202 and distribution center C 206 are two arrows, indicating bi-directional transport between the distribution centers 202, 206 can occur.

As disclosed herein, the graph illustrated in FIG. 2 can be updated such that the edges between the nodes 202-208 change, shift, or are otherwise modified based on real-time conditions detected by the system. The updated graph is then used for future assignments of transports, and can be further updated over time.

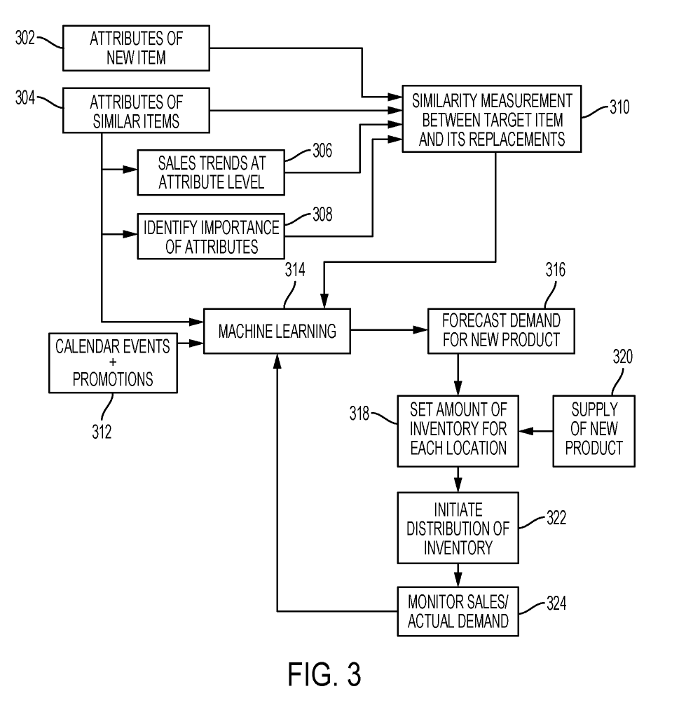

FIG. 3 illustrates an exemplary flowchart for predicting inventory levels using machine learning. In this example, attributes of a new item 302 are entered into a system (such as a server configured to perform machine learning). These attributes 302 can, for example, be obtained through the use of three dimensional scanning, manual entry, or other mechanisms. The system obtains attributes of items similar 304 to the new product, as well as sales trends based on those attributes 306 and the relative importance of those attributes 308 in sales. This data 304, 306, 308 regarding similar products is combined with the data regarding the new product attributes 302, to yield a similarity measurement between the target (new) item and possible replacement items 310.

Based on the similarity measurement, the system conducts machine learning 314 using, for example, the attributes of the similar items 304 (which can include the sales trends 306 and relative importance of attributes 308 of those items), as well as information such as calendar events, holidays, marketing/advertising information/promotions, 312, etc. In addition, the inputs can further include the attributes of the new item 302. The machine learning algorithm 314 generates a forecast demand for the new product 316, which allows the system to set an amount of inventory for each location 318. In determining how much inventory to store at each location, the system can further rely upon the total supply of the new product available 320.

The system then initiates the initial distribution of the product to the distribution centers and retail locations 322 based on the based on the previous determinations. The system monitors the sales (i.e., the actual, but previous, demand of the new product) and uses those sales numbers to modify the machine learning algorithm 314. Thus, with each iteration, the machine learning algorithm 314 is updated based on a comparison of the predicted demand and the actual sales of the new item.

Please note that the exemplary flowchart illustrated in FIG. 3 can be modified as required for specific configurations. For example, individual steps may be added or removed, or different components used in making determinations than illustrated. In addition, the process illustrated in FIG. 3 to project demand 316 produced for a new product 302 can likewise be used for projecting the inventory needed at both retail locations and distribution centers. For example, the machine learning 314, similarity measurements 310, historical data, etc., can all be used to determine the amount of inventory of a product which should be held at both distribution centers and retail centers.

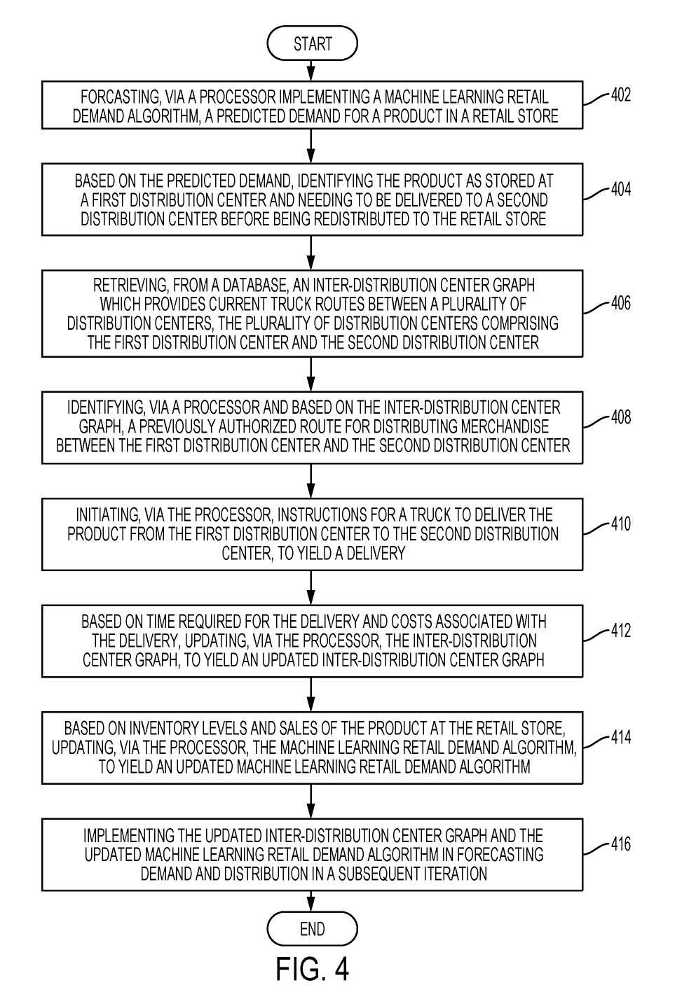

FIG. 4 illustrates an exemplary method embodiment. The steps outlined herein are exemplary and can be implemented in any combination thereof, including combinations that exclude, add, or modify certain steps. For purposes of explanation, the method of FIG. 4 is being performed by a server or other computing device configured to receive real-time inventory information simultaneously from multiple retail locations while, in parallel, generating the improved inter-distribution center graphs disclosed herein.

In this example, the server forecasts, via a processor implementing a machine learning retail demand algorithm, a predicted demand for a product in a retail store (402). The server then identifies, based on the predicted demand, the product as stored in a first distribution center and needing to be delivered to a second distribution center before being redistributed to the retail store (404). The server retrieves, from a database, an inter-distribution center graph which provides current truck routes between a plurality of distribution centers, the plurality of distribution centers comprising the first distribution center and the second distribution center (406). The server then initiates, via the processor, instructions for a truck to deliver the product from the first distribution center to the second distribution center, to yield a delivery (410). Based on the time required for the delivery and costs associated with the delivery, updating, via the processor, the inter-distribution center graph, to yield an updated inter-distribution center graph (412). Likewise, based on inventory levels and sales of the product at the retail store, the server updates, via the processor, the machine learning retail demand algorithm, to yield an updated machine learning retail demand algorithm (414). The server then implements the updated inter-distribution center graph and the updated machine learning retail demand algorithm in forecasting demand and distribution in a subsequent iteration (416).

The previously authorized route identified by the inter-distribution center graph between the first distribution center and the second distribution center does not need to be a direct route. For example, the previously authorized route can move the product from the first distribution center to a third distribution center, then from the third distribution center to the second distribution center.

The inter-distribution center graph described can have nodes comprising the plurality of distribution centers and edges comprising authorized routes between the nodes. Updating the inter-distribution center graph can require at least one of removing at least one edge or adding at least one edge to the inter-distribution center graph. Routes within the inter-distribution center graph can be, for example, authorized when identified as a preferred route within the inter-distribution center graph. This identification can take the form of weighting the edge associated with a route, or can take the form of removing edges which are not the preferred route.

Updating the machine learning retail demand algorithm can occur on a periodic basis, such as hourly, daily, weekly, monthly, quarterly, or yearly. Moreover, the updating of the machine learning retail demand algorithm can use the inter-distribution center graph and/or the updated inter-distribution center graph. In one configuration, updates to the algorithm can be based on the differences between the inter-distribution center graph and the updated inter-distribution center graph. Updating both the machine learning retail demand algorithm and the inter-distribution center graph can be performed to improve profitability to the retailer associated with both the distribution centers and retail locations. In some configurations, the updating process can identify the maximum profitable cost for transporting a product from the first distribution center to the second distribution center, then use that maximum profitable cost in updating the graph and/or updating the machine learning retail demand algorithm.

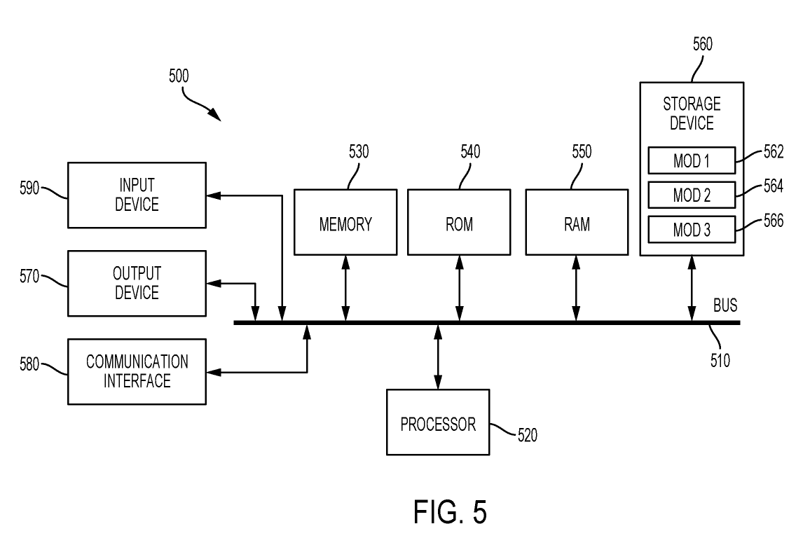

FIG. 5 illustrates an exemplary computer system which can be used to practice the concepts disclosed herein. More specifically, FIG. 5 illustrates a general-purpose computing device 500, including a processing unit (CPU or processor) 520 and a system bus 510 that couples various system components including the system memory 530 such as read only memory (ROM) 540 and random access memory (RAM) 550 to the processor 520. The system 500 can include a cache of high speed memory connected directly with, in close proximity to, or integrated as part of the processor 520. The system 500 copies data from the memory 530 and/or the storage device 560 to the cache for quick access by the processor 520. In this way, the cache provides a performance boost that avoids processor 520 delays while waiting for data. These and other modules can control or be configured to control the processor 520 to perform various actions. Other system memory 530 may be available for use as well. The memory 530 can include multiple different types of memory with different performance characteristics. It can be appreciated that the disclosure may operate on a computing device 500 with more than one processor 520 or on a group or cluster of computing devices networked together to provide greater processing capability. The processor 520 can include any general purpose processor and a hardware module or software module, such as module 1 562, module 2 564, and module 3 566 stored in storage device 560, configured to control the processor 520 as well as a special-purpose processor where software instructions are incorporated into the actual processor design. The processor 520 may essentially be a completely self-contained computing system, containing multiple cores or processors, a bus, memory controller, cache, etc. A multi-core processor may be symmetric or asymmetric.

The system bus 510 may be any of several types of bus structures including a memory bus or memory controller, a peripheral bus, and a local bus using any of a variety of bus architectures. A basic input/output (BIOS) stored in ROM 540 or the like, may provide the basic routine that helps to transfer information between elements within the computing device 500, such as during start-up. The computing device 500 further includes storage devices 560 such as a hard disk drive, a magnetic disk drive, an optical disk drive, tape drive or the like. The storage device 560 can include software modules 562, 564, 566 for controlling the processor 520. Other hardware or software modules are contemplated. The storage device 560 is connected to the system bus 510 by a drive interface. The drives and the associated computer-readable storage media provide nonvolatile storage of computer-readable instructions, data structures, program modules and other data for the computing device 500. In one aspect, a hardware module that performs a particular function includes the software component stored in a tangible computer-readable storage medium in connection with the necessary hardware components, such as the processor 520, bus 510, display 570, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 500 is a small, handheld computing device, a desktop computer, or a computer server.

Although the exemplary embodiment described herein employs the hard disk 560, other types of computer-readable media which can store data that are accessible by a computer, such as magnetic cassettes, flash memory cards, digital versatile disks, cartridges, random access memories (RAMs) 550, and read only memory (ROM) 540, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 500, an input device 590 represents any number of input mechanisms, such as a microphone for speech, a touch-sensitive screen for gesture or graphical input, keyboard, mouse, motion input, speech and so forth. An output device 570 can also be one or more of a number of output mechanisms known to those of skill in the art. In some instances, multimodal systems enable a user to provide multiple types of input to communicate with the computing device 500. The communications interface 580 generally governs and manages the user input and system output. There is no restriction on operating on any particular hardware arrangement and therefore the basic features here may easily be substituted for improved hardware or firmware arrangements as they are developed.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. A method comprising:
forecasting, via a processor implementing a machine learning retail demand algorithm, a predicted demand for a product in a retail store, wherein the machine learning retail demand algorithm uses a real-time inventory level of the product in the store with historical sales data to identify the predicted demand;
based on the predicted demand and by accessing, in real time, a distribution center inventory system, identifying the product as stored at a first distribution center and needing to be delivered to a second distribution center before being redistributed to the retail store;
retrieving, from a database, an inter-distribution center graph which provides current truck routes between a plurality of distribution centers, the plurality of distribution centers comprising the first distribution center and the second distribution center;
identifying, via the processor and based on the inter-distribution center graph, a previously authorized route for distributing merchandise between the first distribution center and the second distribution center;
initiating, via the processor, instructions for a transport to deliver the product from the first distribution center to the second distribution center, to yield a delivery;
based on time required for the delivery and costs associated with the delivery, updating, via the processor, the inter-distribution center graph, to yield an updated inter-distribution center graph, wherein the updated inter-distribution center graph has at least one inter-distribution center route with a lower cost for moving goods from a first distribution center to a second distribution center than a cost for moving the goods from the first distribution center to the second distribution center using routes provided by the inter-distribution center graph;
based on inventory levels and sales of the product at the retail store, updating, via the processor, the machine learning retail demand algorithm, to yield an updated machine learning retail demand algorithm; and
implementing the updated inter-distribution center graph and the updated machine learning retail demand algorithm in forecasting demand and distribution in a subsequent iteration.

2. The method of claim 1, wherein the previously authorized route moves the product from the first distribution center to a third distribution center, then from the third distribution center to the second distribution center.

3. The method of claim 1, wherein the inter-distribution center graph has nodes comprising the plurality of distribution centers and edges comprising authorized routes between the nodes.

4. The method of claim 3, wherein the updating of the inter-distribution center graph comprises removing at least one edge and adding at least one edge to the inter-distribution center graph.

5. The method of claim 1, wherein the updating of the machine learning retail demand algorithm occurs on a periodic basis.

6. The method of claim 5, wherein the periodic basis is daily.

7. The method of claim 1, wherein routes are authorized when identified as a preferred route within the inter-distribution center graph.

8. The method of claim 1, further comprising identifying a maximum profitable cost for delivering the product from the first distribution center to the second distribution center.

9. A system comprising:
a processor; and
a computer-readable storage medium having instructions stored which, when executed by the processor, cause the processor to perform operations comprising:
forecasting, via a machine learning retail demand algorithm, a predicted demand for a product in a retail store, wherein the machine learning retail demand algorithm uses a real-time inventory level of the product in the retail store with historical sales data to identify the predicted demand;
based on the predicted demand and by accessing, in real-time, a distribution center inventory system, identifying the product as stored at a first distribution center and needing to be delivered to a second distribution center before being redistributed to the retail store;
retrieving, from a database, an inter-distribution center graph which provides current truck routes between a plurality of distribution centers, the plurality of distribution centers comprising the first distribution center and the second distribution center;
identifying, based on the inter-distribution center graph, a previously authorized route for distributing merchandise between the first distribution center and the second distribution center;
initiating instructions for a truck to deliver the product from the first distribution center to the second distribution center, to yield a delivery;
based on time required for the delivery and costs associated with the delivery, updating the inter-distribution center graph, to yield an updated inter-distribution center graph, wherein the updated inter-distribution center graph has at least one inter-distribution center route with a lower cost for moving goods from a first distribution center to a second distribution center than a cost for moving the goods from the first distribution center to the second distribution center using routes provided by the inter-distribution center graph;
based on inventory levels and sales of the product at the retail store, updating the machine learning retail demand algorithm, to yield an updated machine learning retail demand algorithm; and
implementing the updated inter-distribution center graph and the updated machine learning retail demand algorithm in forecasting demand and distribution in a subsequent iteration.

10. The system of claim 9, wherein the updating of the machine learning retail demand algorithm is further based on the updated inter-distribution center graph.

11. The system of claim 9, wherein the previously authorized route moves the product from the first distribution center to a third distribution center, then from the third distribution center to the second distribution center.

12. The system of claim 9, wherein the inter-distribution center graph has nodes comprising the plurality of distribution centers and edges comprising authorized routes between the nodes.

13. The system of claim 12, wherein the updating of the inter-distribution center graph comprises removing at least one edge and adding at least one edge to the inter-distribution center graph.

14. The system of claim 9, wherein the updating of the machine learning retail demand algorithm occurs on a periodic basis.

15. The system of claim 14, wherein the periodic basis is daily.

16. The system of claim 9, wherein routes are authorized when identified as a preferred route within the inter-distribution center graph.

17. The system of claim 9, the computer-readable storage medium having additional instructions stored which, when executed by the processor, cause the processor to perform operations comprising identifying a maximum profitable cost for delivering the product from the first distribution center to the second distribution center.

18. A non-transitory computer-readable storage medium having instructions stored which, when executed by a computing device, cause the computing device to perform operations comprising:
forecasting, via a machine learning retail demand algorithm, a predicted demand for a product in a retail store;
based on the predicted demand, identifying the product as stored at a first distribution center and needing to be delivered to a second distribution center before being redistributed to the retail store;
retrieving, from a database, an inter-distribution center graph which provides current truck routes between a plurality of distribution centers, the plurality of distribution centers comprising the first distribution center and the second distribution center;
identifying, based on the inter-distribution center graph, a previously authorized route for distributing merchandise between the first distribution center and the second distribution center;
initiating instructions for a truck to deliver the product from the first distribution center to the second distribution center, to yield a delivery;
based on time required for the delivery and costs associated with the delivery, updating the inter-distribution center graph, to yield an updated inter-distribution center graph;
based on inventory levels and sales of the product at the retail store, updating the machine learning retail demand algorithm, to yield an updated machine learning retail demand algorithm; and
implementing the updated inter-distribution center graph and the updated machine learning retail demand algorithm in forecasting demand and distribution in a subsequent iteration.

19. The non-transitory computer-readable storage medium of claim 18, wherein the previously authorized route moves the product from the first distribution center to a third distribution center, then from the third distribution center to the second distribution center.

20. The non-transitory computer-readable storage medium of claim 18, wherein the inter-distribution center graph has nodes comprising the plurality of distribution centers and edges comprising authorized routes between the nodes.
